(19) United States
(12) Patent Application Publication
(10) Pub. No.: US 2009/0198781 A1
(43) Pub. Date: Aug. 6, 2009

(54) SOLUTION THAT OPTIMIZES A WEBSPHERE CORE GROUP BRIDGE TO HANDLE PEER CORE GROUP MESSAGING FOR A DISTRIBUTED COMPUTING SYSTEM WITH A LARGE TOPOLOGY

(75) Inventors: JACQUELLE D. LEGGETT, RALEIGH, NC (US); JAKOB L. MICKLEY, RALEIGH, NC (US); JAMES W. STOPYRO, ROCHESTER, MN (US); DANA R. THALHEIMER, CARY, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/025,257

(22) Filed: Feb. 4, 2008

(51) Int. Cl. G06F 15/16

(52) U.S. Cl. 709/206

(57) ABSTRACT

The present invention discloses a solution to optimize a manner in which core group communications are handled. In the solution, a message to be conveyed from one core group to a different core group can be identified. The message can be encased in a bridge wrapper. This encasing does not alter a format or content of the identified message. The encased message can be conveyed to the different core group. A processing of the encased message by the different core group can be dependent upon the bridge wrapper and can be dependent upon a network topology connecting the core groups. For example, the bridge wrapper can permit bridges to selectively forward posts, subscriptions, and status messages to non-sending core groups in a chain topology implementation. In a mesh topology, use of the bridge wrapper can enable a bridge to resent and/or remove local posts.

### BACKGROUND

1. Field of the Invention

The present invention relates to the field of information services processing and, more particularly, to improving the efficiency of core group message handling for a distributed computing system with a large topology.

2. Description of the Related Art

Communications between peer core groups is critical for providing efficient processing of service requests in a service-oriented architecture (SOA). Since core groups are often used to encapsulate high availability domains, timely message handling is necessary to ensure that service requests are routed to other core groups in the case of service failure or high volume. Typically, a specific service, such as the core group bridge in WEBSPHERE, handles the message traffic between peer core groups.

While this architecture is effective at providing communication pathways between core groups, it can break down as the quantity of core groups and/or servers within the core groups increases into what is known as a large topology. In the case of a large topology, communication pathways can become clogged with the multitude of messages being sent. For example, if ten servers in Core Group A all subscribe to Service A in Core Group B, then ten subscription messages are sent from Core Group A to Core Group B. Core Group B must then process each of those ten messages and provide the necessary post messages back to Core Group A, which is duplicated ten times—once for each requesting server. Thus, as the amount of message traffic increases, consumption of system resources increases and system performance decreases.

Another factor compounding this problem is that the messaging service handles all topologies in the same manner. The efficiency of message handling could be improved by using delivery algorithms that take advantage of topological differences and architectures. For example, a chain topology requires that a message be passed linearly through the chain of core groups, which is not required in a mesh topology.

What is needed is a solution that provides efficient message handling between core groups in large topology distributed computing systems, such as a SOA. That is, the message handler would streamline the messaging processes for system topology and eliminate redundant messaging. Ideally, this solution would automatically determine the system topology and adjust the messaging configuration of the core group bridge accordingly.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram illustrating a system that optimizes a WEBSPHERE core group bridge 115 to handle peer core group messaging in a large topology distributed computing system in accordance with embodiments of the inventive arrangements disclosed herein.

FIGS. 1A and 1B each illustrate the basic core group topologies of chain and mesh, respectively.

FIG. 2 is a flow chart of a method for the initial handling of core group messages by an optimized core group bridge in accordance with an embodiment of the inventive arrangements disclosed herein.

FIG. 3 is a flow chart of a method for determining the topology of peer core groups in accordance with an embodiment of the inventive arrangements disclosed herein.

FIG. 4 is a collection of flow charts illustrating methods for the handling of subscription messages by an optimized core group bridge in accordance with an embodiment of the inventive arrangements disclosed herein.

FIG. 5 is a collection of flow charts illustrating methods for the handling of post messages by an optimized core group bridge in accordance with an embodiment of the inventive arrangements disclosed herein.

FIG. 6 is a collection of flow charts illustrating methods for the handling of stop/failure messages by an optimized core group bridge in accordance with an embodiment of the inventive arrangements disclosed herein.

### DETAILED DESCRIPTION OF THE INVENTION

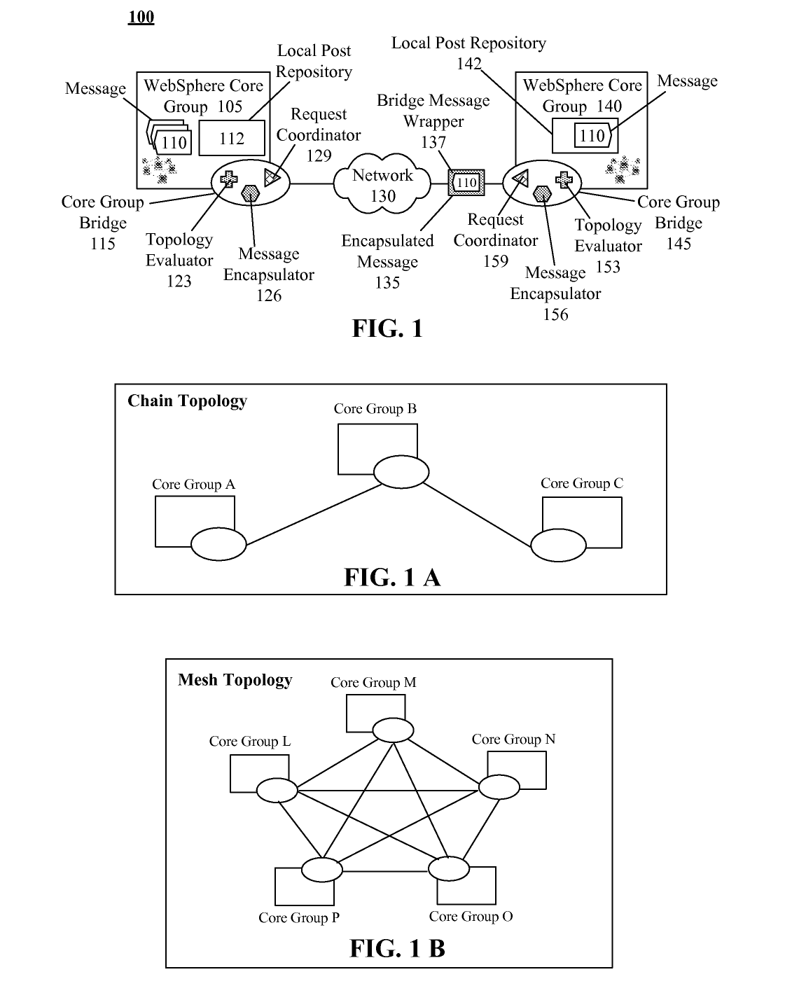

FIG. 1 is a schematic diagram illustrating a system 100 that optimizes a WEBSPHERE core group bridge 115 to handle peer core group messaging in a large topology distributed computing system in accordance with embodiments of the inventive arrangements disclosed herein. It should be noted that system 100 illustrates a small-scale version for illustrative purposes; messaging between only two WEBSPHERE core groups 105 and 140, herein referred to as core groups, and not a large topology system. As used herein, the term “large topology” defines a distributed computing system consisting of at least three core groups, each handling traffic for five or more servers.

In large topology systems that generate a high volume of message traffic between peer core groups, the existing message handling by the core group bridge was found to lack an efficiency needed to provide timely transmission and processing for high availability domains. The present invention addresses this issue by modifying the core group bridge to act more like a communications coordinator and less as an open communications gateway.

In system 100, a peer-to-peer relationship can exist between the core groups 105 and 140. That is, neither core group 105 or 140 can have a hierarchically higher or lower relationship to each other. A core group 105 can represent a grouping of servers and/or related software components that provide services in a service-oriented architecture (SOA). The peer relationship between core groups 105 and 140 can allow for a core group to be aware of available services and key events in the other core groups. As such, service requests can be rerouted to servers in other peer core groups should a failure occur or to handle a high request volume.

A core group 105 can transmit a multitude of messages 110 to other core groups, such as core group 140 over a network 130. The messages 110 can include a variety of data, such as subscription messages, post messages, and status messages. Transmission of the messages 110 can be overseen by the core group bridge 115 associated with the core group 105.

The core group bridge 115 can represent a service initiated by the core group 105 to handle messaging to the core group bridge 145 of other peer core groups 140. The core group bridge 115 can include a topology evaluator 123, a message encapsulator 126, and a request coordinator 129.

The topology evaluator 123 can correspond to a software component and/or algorithm designed to determine the topology connecting the core bridge's 115 local core group 105 with its peer core groups 140. Topologies that can be determined by the topology evaluator 123 can include a chain, shown in FIG. 1A, and a mesh, shown in FIG. 1B, as basic configurations, with larger and/or distributed topologies being comprised of multiples of each basic configuration and/or in varying combinations.

Upon determination of the topology, the topology evaluator 123 can set one or more corresponding values in the core group bridge 115 to designate the determined topology. The setting of these values can affect the message delivery behavior of the core group bridge 115. For example, determination of a chain topology can set a data attribute for message forwarding to “yes” or “enable” in order to signify that a message 110 should be forwarded through the chain of core groups.

The message encapsulator 126 can correspond to a software component that envelops a message 110 with an appropriate bridge message wrapper 137, creating an encapsulated message 135. For example, a subscription request message 110 can be encased in a subscription-oriented bridge message wrapper 137. The bridge message wrapper 137 can be a specialized message that can encase a message 110 from a core group 105 that alters the processing of the encased message 110. It should be noted that the format and/or contents of the message 110 are not altered by the addition of the bridge message wrapper 137.

These changes in the processing of the message 110 can include the replacement of multiple subscription and/or post messages 110 from individual core group 105 members with a single subscription and/or post message at the core group bridge 115 level. That is, the core group bridge 115 can subscribe to an information service in another core group 140 on behalf of the members of its local core group 105. A single subscription, therefore, means the receipt of a single return post message 110. The contents of a post message 110 can be stored in a local post repository 142 in the core group 140, where it can be accessed at any time by any member of the core group 140.

It should be appreciated that these processing alterations can result in a significant reduction in the quantity of subscription, post, and stop/failure messages 110 that need to be transmitted and processed within the system 100. The following table quantifies the savings in required messages 110 that can be achieved utilizing the present invention.

| | Message | Conventional | Present |
|---|---|---|---|
| Event | Type | Implementation | Invention |
| Server Startup - The total | Subscription | C > 2: C * {(C − 2) * [(C − 1) * S]} | C * [(C − 1) * S] |
| number of bridge messages | | C = 2: C * S | |
| sent when starting all the | Post | C > 2: C * {(C − 2) * [(C − 1) * S]} | C * [(C − 1) * S] |
| servers in a topology. | | C = 2: C * S | |
| Bridge Fail-Over - The | Subscription | C > 2: C * {(C − 2) * [(C − 1) * S]} | C * [(C − 1) * S] |
| total number of bridge | | C = 2: C * S | |
| messages sent by the | Post | C * (C − 1) | (C − 1) |
| remaining bridges to | | | |
| recover state when a bridge | | | |
| fails. | | | |

C = # of core groups;
S = # of servers per core group
NOTE:
Assumes all core groups are configured in a mesh topology. Also assumes all servers subscribe to the same subject and post once to the subscribed subject. If C = 1, no bridge required.

The proceeding equations can be better understood by using an example with numeric values. For example, let us use a system consisting of nine core groups in a mesh topology with each core group comprising fifty servers. The following table displays the calculation results associated with such an example.

| | | Conventional | Present |
|---|---|---|---|
| Event | Message Type | Implementation | Invention |
| Server Startup | Subscription | 25,200 | 3600 |
| | Post | 25,200 | 3600 |
| Bridge Fail-Over | Subscription | 25,200 | 3600 |
| | Post | 72 | 8 |

As shown in the above table, an 86% reduction in subscription messaging can be achieved with the present invention. The reduction for post messages 110 at server startup can also be quite considerable with an 88% reduction for bridge fail-over.

The request coordinator 129 can correspond to the software component and/or algorithm that can determine the handling of messages 110 from its local core group 105. The request coordinator 129 can examine each received request and determine if the core group bridge 115 is already subscribed to the service. In cases where a subscription already exists, the request coordinator 129 can provide the requesting member with the corresponding data stored in the local post repository 112. Thus, the service request can be fulfilled without the need for reprocessing the subscription.

Network 130 can include any hardware/software/and firmware necessary to convey data encoded within carrier waves. Data can be contained within analog or digital signals and conveyed though data or voice channels. Network 130 can include local components and data pathways necessary for communications to be exchanged among computing device components and between integrated device components and peripheral devices. Network 130 can also include network equipment, such as routers, data lines, hubs, and intermediary servers which together form a data network, such as the Internet. Network 130 can also include circuit-based communication components and mobile communication components, such as telephony switches, modems, cellular communication towers, and the like. Network 130 can include line based and/or wireless communication pathways.

Information used by the various components of system100 can be digitally encoded within one or more data stores, which can be physical or virtual storage spaces configured to store digital information. The data stores can be physically implemented within any type of hardware including, but not limited to, a magnetic disk, an optical disk, a semiconductor memory, a digitally encoded plastic memory, a holographic memory, or any other recording medium. The data stores can be a stand-alone storage unit as well as a storage unit formed from a plurality of physical devices. Additionally, information can be stored within the data stores in a variety of manners. For example, information can be stored within a database structure or can be stored within one or more files of a file storage system, where each file may or may not be indexed for information searching purposes. Further, the data stores can utilize one or more encryption mechanisms to protect stored information from unauthorized access.

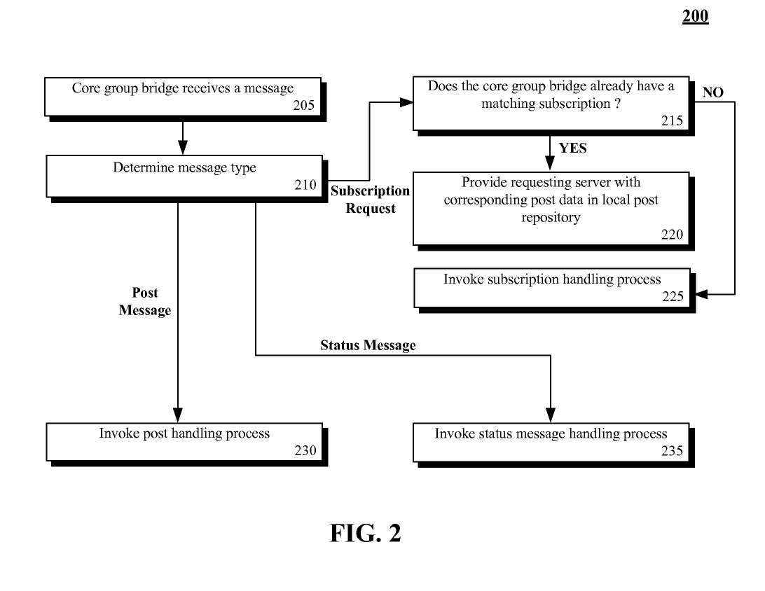

FIG. 2 is a flow chart of a method 200 for the initial handling of core group messages by an optimized core group bridge in accordance with an embodiment of the inventive arrangements disclosed herein. Method 200 can be utilized by the request coordinators 129 and 159 of system 100.

Method 200 can begin with step 205 where the core group bridge can receive a message. In step 210, the type of message received can be determined. When the message is determined to be a post message, flow can proceed to step 230 where the post handling process can be invoked. When the message is determined to be a status message, flow can proceed to step 235 where the status message handling process can be invoked.

When the message is determined to be a subscription request, flow can proceed to step 215 where it can be determined if the core group bridge already has a subscription for the request. If a subscription already exists, step 220 can execute where the core group bridge can provide the requesting server with the corresponding post data from the local post repository. If a subscription does not exist, then the subscription handling process can be invoked in step 225.

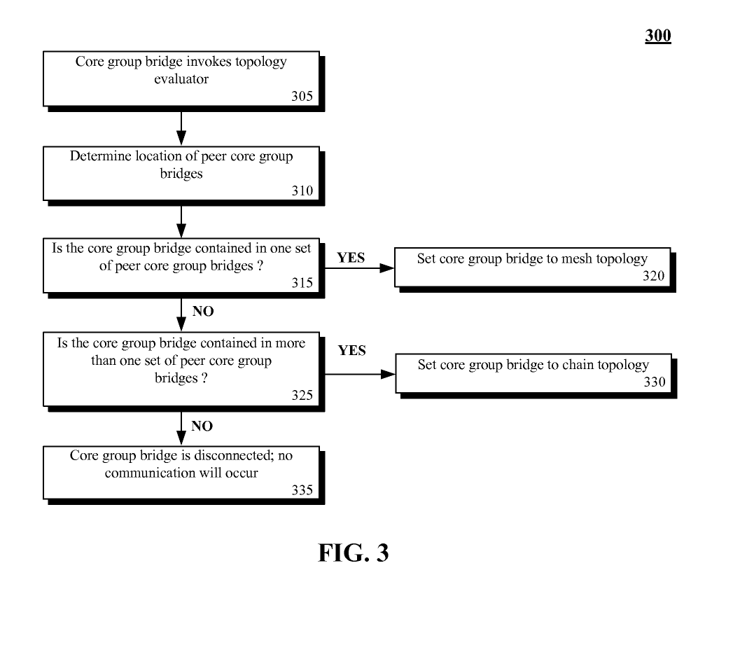

FIG. 3 is a flow chart of a method 300 for determining the topology of peer core groups in accordance with an embodiment of the inventive arrangements disclosed herein. Method 300 can be utilized by the topology evaluators 123 and 153 of system 100.

Method 300 can begin with step 305 where a core group bridge can invoke its topology evaluator. In step 310, the topology evaluator can determine the location of peer core group bridges. When the core group bridge is determined to be contained in exactly one set of peer core group bridges, the step 320 can execute where the core group bridge can be set to handle a mesh topology. A mesh topology can be determined since all core groups are directly connected to each other in a mesh, meaning that all groups are in the same set.

When the core group bridge is not contained in exactly one set of peer core group bridges, the step 325 can execute where it can be determined if the core group bridge is contained in more than one set of peers. If the core group bridge is contained in more than one set of peer core group bridges, then the core group bridge can be set to a chain topology. A chain topology can be determined since a core group must pass through multiple core sets with differing peers.

If the core group bridge is found not be contained in more than one peer set, then it can be determined that the core group bridge is disconnected and no communication can occur. This situation can signify a core group bridge failure in the core group bridge itself or its immediate peer core group bridges.

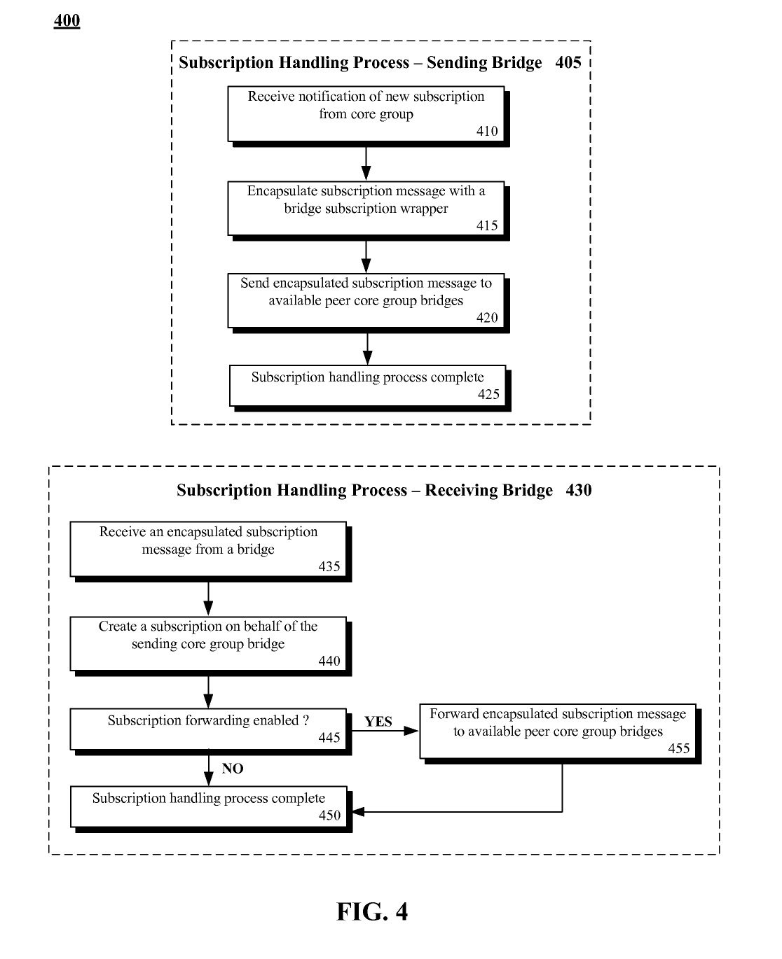

FIG. 4 is a collection 400 of flow charts illustrating methods 405 and 430 for the handling of subscription messages by an optimized core group bridge in accordance with an embodiment of the inventive arrangements disclosed herein. The methods of collection 400 can be utilized by the request coordinators 129 and 159 of system 100.

Collection 400 can comprise two separate methods 405 and 430 for handling subscription messages based on whether the core group bridge is sending or receiving the subscription message. When the core group bridge is sending a subscription message, method 405 can be executed.

Method 405 can begin with step 410 where the core group bridge can receive notification of a new subscription from its core group. In step 415, the subscription message can be encapsulated with a bridge subscription wrapper. The encapsulated subscription message can be sent to available peer core group bridges in step 420. In step 425, the subscription handling process can be deemed complete.

When the core group bridge is receiving a subscription message, method 430 can be executed. Method 430 can begin with step 435 where an encapsulated subscription message can be received by the core group bridge. In step 440, a subscription can be created on behalf of the sending core group bridge.

In step 445, it can be determined if the receiving core group bridge has subscription forwarding enabled. Message forwarding can be a process that is enabled when a chain topology is determined in order for a message to be propagated down the chain. When subscription forwarding is enabled, step 455 can execute where the encapsulated subscription message can be forwarded to available peer core group bridges. Step 450 can execute when subscription forwarding is disabled or after the execution of step 455 where the subscription handling process can be deemed complete.

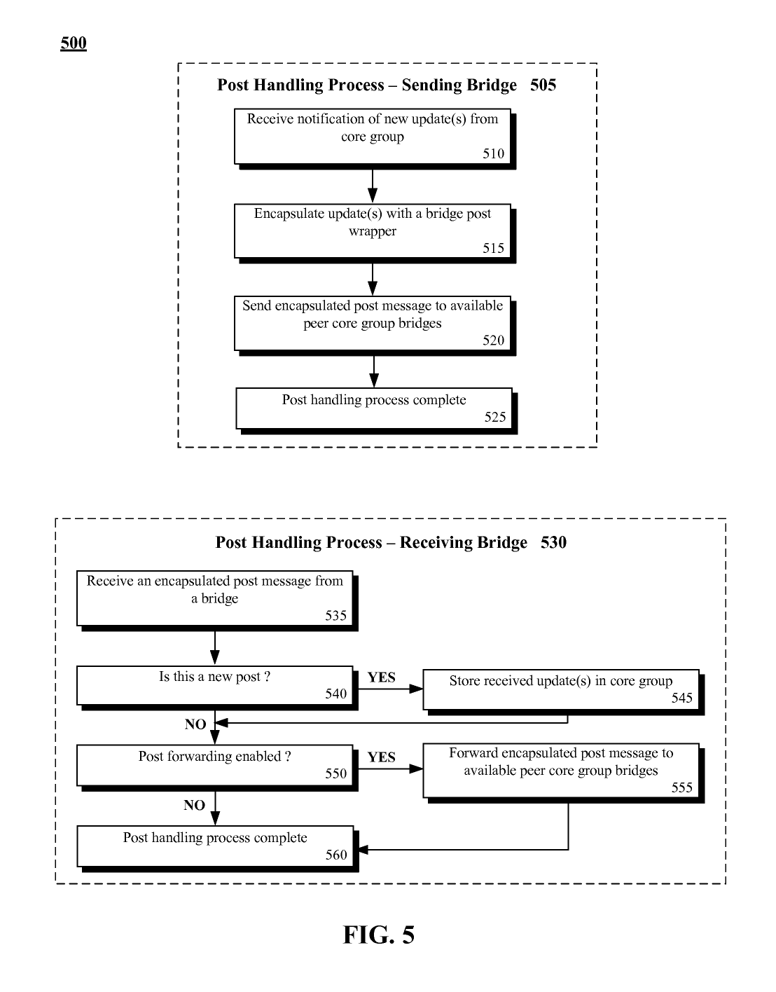

FIG. 5 is a collection 500 of flow charts illustrating methods 505 and 530 for the handling of post messages by an optimized core group bridge in accordance with an embodiment of the inventive arrangements disclosed herein. The methods of collection 500 can be utilized by the request coordinators 129 and 159 of system 100.

Collection 500 can comprise two separate methods 505 and 530 for handling post messages based on whether the core group bridge is sending or receiving the post message. When the core group bridge is sending a post message, method 505 can be executed.

Method 505 can begin with step 510 where the core group bridge can receive notification of a new update or updates from its core group. In step 515, the update can be encapsulated with a bridge post wrapper. The encapsulated post message can be sent to available peer core group bridges in step 520. In step 525, the post handling process can be deemed complete.

When the core group bridge is receiving a post message, method 530 can be executed. Method 530 can begin with step 535 where an encapsulated post message can be received by the core group bridge. In step 540 it can be determined if the received post contains new data.

When it is determined that the received post contains new data, step 545 can execute where the received update can be stored in the core group, such as the local post repository 112 of system 100. When it is determined that the received post does not contain new data or upon the completion of step 545, flow can proceed to step 550 where it can be determined if post forwarding is enabled for the core group bridge.

When post forwarding is enabled, step 555 can execute where the encapsulated post message can be forwarded to available peer core group bridges. Step 560 can execute when post forwarding is disabled or after the execution of step 555 where the post handling process can be deemed complete.

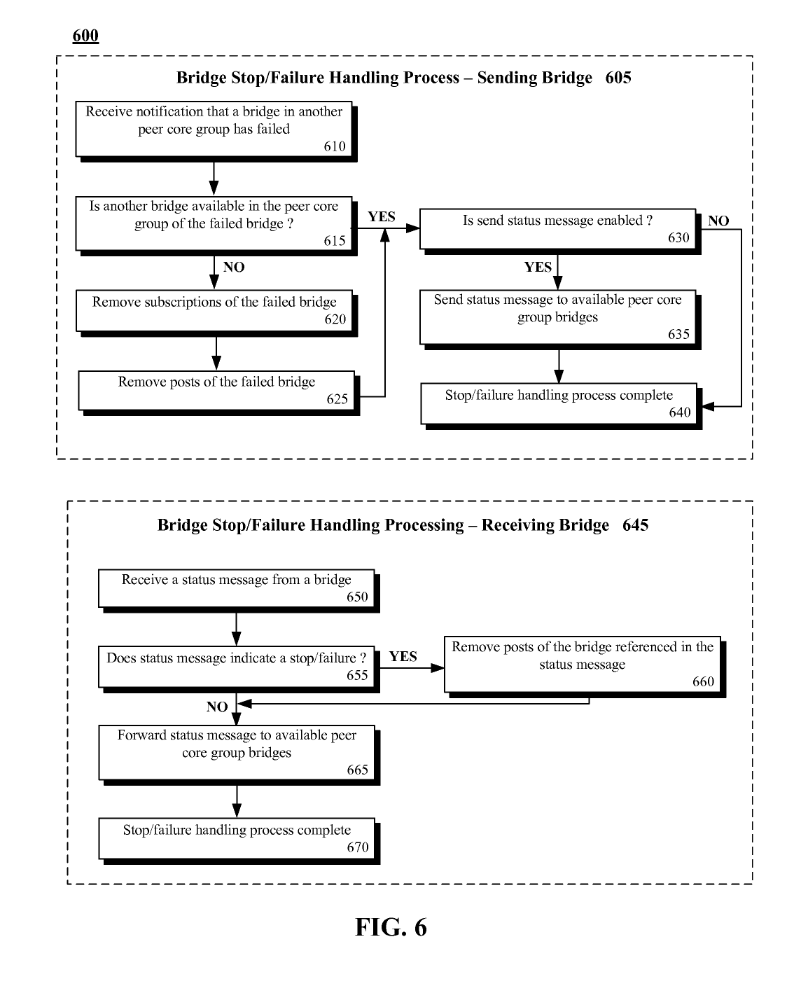

FIG. 6 is a collection 600 of flow charts illustrating methods 605 and 645 for the handling of stop/failure messages by an optimized core group bridge in accordance with an embodiment of the inventive arrangements disclosed herein. Collection 600 can comprise two separate methods 605 and 645 for handling stop/failure messages based on whether the core group bridge is sending or receiving the stop/failure message.

When the core group bridge is sending a stop/failure message, method 605 can be executed. Method 605 can begin with step 610 where the core group bridge can receive notification that a core group bridge in another peer core group has failed. In step 615, it can be determined if another core group bridge is available in the peer core group containing the failed bridge.

If another bridge is unavailable in that core group, the subscriptions of the failed core group bridge can be removed from the sending core group bridge in step 620. In step 625, the post data from the failed core group bridge can be removed.

If another bridge is available in that core group or upon the completion of step 625, step 630 can execute where it can be determined the core group is enabled to send status messages. When the core group bridge is able to send status messages, step 635 can execute where the core group bridge sends a status message to its available peer group bridges. When the core group bridge is unable to send status messages or upon the completion of step 635, step 640 can execute where the stop/failure handling process can be deemed complete.

When the core group bridge is receiving a stop/failure message, method 645 can be executed. Method 645 can begin with step 650 where the core group bridge can receive a status message from another peer core group bridge. In step 655, it can be determined if the status message indicates a stop/failure in a peer core group bridge.

If the status message does indicate a core group bridge stop/failure, then step 660 can execute where the receiving core group bridge can remove the posts of the core group bridge referenced in the status message. If the status message does not indicate a core group bridge stop/failure or upon the completion of step 660, the status message can be forwarded to available peer core group bridges in step 665. In step 670, the stop/failure handling process can be deemed complete.

The present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method for processing messages between core groups comprising:
identifying a message to be conveyed from one core group to a different core group;
encasing said message in a bridge wrapper, wherein said encasing step does not alter a format of said identified message and does not alter content of said identified message; and
conveying said encased message to the different core group, wherein a processing of the encased message by said different core group is dependent upon said bridge wrapper.

2. The method of claim 1, wherein different types of bridge wrappers exist, said types of bridge wrappers comprising a subscription type wrapper for subscription messages, and a post type wrapper for post messages

3. The method of claim 1, wherein said bridge wrapper causes the processing to vary depending upon a type of topology used to connect said core group and said different core group, wherein permissible ones of said type of topology comprise a mesh topology and a chain topology.

4. The method of claim 1, wherein said bridge wrapper permits the different core group to resend local posts to subscribed core groups that experience a bridge start/stop event.

5. The method of claim 1, wherein said one core group and said different core group are part of a plurality of interconnected core groups, which are connected using a chain topology, wherein said bridge wrapper permits a core group bridge of the different core group to forward subscriptions and posts to non-sending core groups.

6. The method of claim 1, wherein said one core group and said different core group are part of a plurality of interconnected core groups, which are connected using a chain topology, wherein said bridge wrapper permits a core group bridge of the different core group to generate status messages to propagate a state of a failing bridge to other connected ones of said interconnected peer groups.

7. The method of claim 1, wherein a different core bridge associated with the different core group is used to perform the processing of the encased message, wherein said core bridge and said different core bridge are each a service of a JAVA 2 ENTERPRISE EDITION (J2EE) APPLICATION SERVER.

8. The method of claim 7, wherein said J2EE APPLICATION SERVER is a WEBSPHERE APPLICATION SERVER and wherein each of the core groups is a WEBSPHERE core group.

9. The method of claim 1, wherein said one core group and said different core group are included in a plurality of communicatively linked core groups, wherein each of the core groups comprises at least five servers, wherein each of the core groups is associated with a group specific core bridge, wherein said group specific core bridges enable communications between said core groups, and wherein a peer relationships exists between each of the group specific core bridges.

10. The method of claim 1, wherein said steps of claim 1 are performed by at least one machine in accordance with at least one computer program stored in a computer readable media, said computer programming having a plurality of code sections that are executable by the at least one machine.

11. A core group bridge optimized to handle peer core group messaging of a distributed computing system with a large topology comprising:
a topology evaluator configured to determine a topology of a plurality of core groups, wherein a peer relationship exists between the plurality of core groups, and wherein the determined topology defines a set of message transmission parameters for a core group bridge;
a request coordinator configured to determine a need to transmit a message received by the core group bridge from an associated core group based on the determined topology, wherein the request coordinator fulfills duplicate messages without the need to transmit the message; and
a message encapsulator configured to encase the message received from the request coordinator with a wrapper, wherein the wrapper modifies a processing of the message when received by other core group bridges contained within the plurality of core groups.

12. The system of claim 11, wherein said core group is a WEBSPHERE core group conforming to WEBSPHERE based standards, wherein said core group bridge is a WEBSPHERE core group bridge conforming to WEBSPHERE based standards.

13. The system of claim 11, wherein each core group is a set of WEBSPHERE APPLICATION SERVER processes configured to communicate for high availability purposes, wherein said core group bridge is a service on a WEBSPHERE APPLICATION SERVER that enables communication between core groups.

14. The bridge of claim 11, wherein each of said core group bridges handles traffic for at least four servers belonging to a core group associated with the core group bridge, and wherein said plurality of core groups consists of at least three core groups, each associated with a group specific core group bridge, each group specific core group bridge comprising said topology evaluator, said request coordinator, and said message encapsulator.

15. The system of claim 11, further comprising:
a post repository local to the associated core group configured to store data, wherein the data is placed in the post repository by the request coordinator.

16. The system of claim 11, wherein the determined topology is at least one of a chain topology and a mesh topology.

17. The system of claim 11, wherein the message received by the request coordinator is at least one of a subscription request, a post message, and a status message.

18. Software for communicating among core groups comprising:
a set of programmatic instructions digitally encoded on a machine readable medium configured to be executed by a computing device, wherein said set of programmatic instructions are part of a service of a JAVA 2 ENTERPRISE EDITION (J2EE) APPLICATION SERVER, wherein said service is a core bridge that enables communication between a plurality of core groups, wherein each of said core groups is associated with a group specific core bridge, wherein said a peer relationship exists between the core bridges, wherein each of said set of programmatic instructions encapsulates each message to be conveyed among the core groups within a bridge wrapper without altering a format and content of the encapsulated message, wherein information associated with the bridge wrapper causes a processing of the received message to vary in accordance with the details specified within the information.

19. The software of claim 18, wherein the plurality of core groups are connected to each other through a chain topography, wherein said set of programmatic instructions directs the associated core group to selectively forward posts, subscriptions, and status messages to non-sending core groups.

20. The software of claim 18, wherein the plurality of core groups are connected to each other through a mesh topology, wherein the set of programmatic instructions resends local posts to subscribed core groups that experience bridge start/stop events.
